(19) United States
(12) Patent Application Publication
(10) Pub. No.: US 2008/0018110 A1
(43) Pub. Date: Jan. 24, 2008

(54) Axle-driven generator for railway carriages and the like

(76) Inventor: Kurt Roth, Watt (CH)

Correspondence Address: LACKENBACH SIEGEL, LLP, LACKENBACH SIEGEL BUILDING, 1 CHASE ROAD, SCARSDALE, NY, 10583, US

(21) Appl. No.: 11/644,239

(22) Filed: Dec. 22, 2006

(30) Foreign Application Priority Data
Dec. 30, 2005 (DE) 10 2005 063 165.7

(51) Int. Cl. B61D 43/00; H02K 7/18

(52) U.S. Cl. 290/3

(57) ABSTRACT

Axle-driven generator for railway carriages and the like, consisting of at least one axle-driven generator, the rotor of which is rotationally engaged with the wheelset shaft and the stator housing of which is secured to the housing. In order to support a large, powerful axle-driven generator, it is provided that the axle-driven generator is placed between the wheel discs directly on the wheelset shaft and said wheelset shaft passes through the axle-driven generator.

### BACKGROUND OF THE INVENTION

1. Field of the Invention

The invention relates to an axle-driven generator for railway carriages according to the preamble of claim 1. The term “railway carriage” refers to all rail-bound, non-self-driven vehicles.

2. Description of the Prior Art

EP 1 033 296 A2 discloses an axle-driven generator which is flanged directly on the axle. However, the end face of the axle-driven generator is flanged directly onto the axle bearing, and this has major drawbacks. The first drawback is that the end-face installation space pointing in the axial direction is markedly delimited at the axle bearing, thus preventing a large generator with a corresponding power output from being mounted at this location. The axle-driven generator is therefore able to protrude beyond the outer end face of the wheelset shaft only by a limited length.

A further drawback is that the guiding of the axle, which has a relatively large diameter, through the axle bearing presents constructional problems. Stub shafts of reduced diameter can therefore be guided out from the end face. However, this means that only low torques can be transmitted to the axle-driven generator, with low stability.

An axle-driven generator of this type is therefore suitable only for measuring speed or distance and not for generating an independent power supply in a railway wagon.

In DE 197 48 392 A1, DE 197 56 904 A1 and also DE 41 19 834 A1 and DE 695 24 014 T2 to, a power generator is attached to a stub shaft branched off from the axle and flanged at this location. However, it is not possible to transmit high torques via a stub shaft of this type.

The power generators disclosed in each of the aforementioned documents are generators, the end face of which is flanged to the wheelset shaft, to which only low torques can be transmitted and which, owing to the delimitation of the axial length of the wheelset shaft, can be only small in their construction, with low electrical power.

Starting from EP 1 033 296 A2, the object of the invention is therefore to develop an axle-driven generator for rail-bound vehicles of the type mentioned at the outset so as to facilitate a high output of the power generator in the installation site provided between the wheel discs.

### SUMMARY OF THE INVENTION

In order to achieve the object set, the invention is characterised by the technical teaching of claim 1.

The fundamental feature of the invention is that the axle-driven generator now sits directly on the wheelset shaft which passes through said axle-driven generator.

The provided technical teaching produces the important advantage that very high torques can now be transmitted directly from the wheelset shaft to the axle-driven generator, as the axle-driven generator is no longer flanged at its end face; instead, it is provided that the wheelset shaft passes directly—approximately in the centre of the wheelset shaft—through said axle-driven generator.

The central installation site on the wheelset shaft is given merely by way of example. In other embodiments, an installation site of from ⅓ to ⅔ of the length of the wheelset shaft can also be provided for the axle-driven generator. Equally, a plurality of axle-driven generators can also be arranged on a wheelset shaft in parallel and set apart from one another.

This eliminates the problem of having to guide relatively unstable stub shafts out from the end face of the wheelset shaft in order to drive an axle-driven generator arranged at this location. The drawbacks of such an arrangement were described at the outset: only relatively low torques can be transmitted to an axle-driven generator which is arranged at the end face and increases—in an undesirable manner—the installation length of the wheelset shaft.

This is the starting point of the invention, in which the axle-driven generator is attached directly to the large wheelset shaft transmitting high torques.

In a development of the present invention, it is provided that the axle-driven generator is of two-part construction and consists of two halves which are arranged substantially mirror-symmetrically to each other and may be screwed together.

A further notable advantage is that the separability of the axle-driven generator allows it to be replaced or repaired in the event of damage without the wheel disc 5 of the railway carriage having to be dismantled. This technical teaching provides for the first time the advantage of simple mounting of the axle-driven generator; this was previously unknown.

Central to the present invention is the feature that a high-power axle-driven generator is intended to facilitate, for a power output of up to 35 kW, a corresponding current output in the range of up to 200 A of alternating current in the case of a three-phase current.

The important thing in this regard is that this power is achieved from a speed as low as 200 rpm, so the power generator is necessarily relatively large in its construction.

The generator is preferably a brushless, permanently excited three-phase generator which has, at a preferred outer diameter of approximately 600 mm, an axial length of approximately 600 mm for a weight of approximately 450 kg. In the past, it was not possible reliably to couple such a large axle-driven generator to the wheelset shaft, let alone to attach it at the end face.

The dimensions and powers indicated above are not to be regarded as restricting the scope of the invention and serve merely to describe a preferred embodiment. They also clearly indicate that the end face of an axle-driven generator of this type cannot—on account of its axial length and its outer diameter—be flanged to a wheelset shaft.

The background of the present invention is that the power generator or a plurality of power generators of the indicated electrical power provide a completely independent power supply for a railway wagon. A railway wagon of this type conventionally has at least a lighting system, a ventilation system and an air-conditioning system. The air-conditioning system involves the powering of a compressor having a relatively high power consumption.

The three-phase alternating-current output of the generator is connected to a converter which powers a battery via a charging module. The current output from the battery provides the entire power supply in the wagon. The electrical consumers arranged in the railway wagon are supplied from the battery with a low DC voltage. This prevents a power failure in the wagon when the wagon is stationary.

However, the invention is not restricted to a battery power supply of this type. A direct supply can also be provided with the axle-driven generator according to the invention. Equally, a plurality of axle-driven generators can be arranged on a wagon. Each wheelset shaft can, for example, carry a generator of this type. A plurality of axle-driven generators can also be arranged on a wheelset shaft.

In the past, continuous, non-separated axle-driven generators have been used; this had the drawback that the generators either had to be flanged at their end face on the wheelset shaft or they had to be arranged on the bogie frame and connected to the wheelset shaft via a transmission belt or other transmission solutions. The invention eliminates the complex transmission means by proposing an axle-driven generator sitting directly on the wheelset shaft.

It has been found that a transmission belt driving an axle-driven generator arranged on the bogie frame is unsuitable for high-speed uses. The wheelset shaft performs major axial and radial displacements and also three-dimensional, oblique movements which rule out drive via a transmission belt.

For this reason, the invention proposes that the axle-driven generator sits directly on the wheelset shaft itself and its rotor is rotationally engaged therewith, whereas the stator is supported in a non-rotatable manner on the bogie frame or another fixed part of the wagon.

The rotationally engaged clamping connection of the rotor on the wheelset shaft may, of course, also be replaced by other interlocking connections such as, for example, keyways, teeth and the like, the shaft receptacle in the axle-driven generator having, for example, corresponding inner teeth by means of which the wheelset shaft engages with associated outer teeth.

All forms of rotational engagement between a wheelset shaft and the rotor of an axle-driven generator are therefore claimed as being instrumental to the invention. Connections of this type can be either of the clamping or of the interlocking type.

It was stated hereinbefore that the axle-driven generator is preferably completely separable, i.e. it consists of two parts which are arranged substantially mirror-symmetrically to each other and are attached to the wheelset shaft using corresponding and suitable screw connections in such a way that the wheelset shaft passes through the inner hole in the axle-driven generator with frictional or interlocking engagement.

In a different embodiment of the invention, it is, however, provided that the axle-driven generator is inseparable, i.e. it is generally a continuous, encircling, approximately rotationally symmetrical part, the wheelset shaft passing through the shaft hole therein, wherein in this case the axle-driven generator is mounted only if the wheel disc and the brake disc are detached from the wheelset shaft.

The following two differing embodiments of the axle-driven generator are therefore claimed as being instrumental to the invention:
1. an axle-driven generator which is separated completely into two halves and can be mounted with its two halves on the wheelset shaft or
2. an inseparable axle-driven generator which is pushed onto the wheelset shaft via the open end face thereof and is arranged approximately in the central region of the wheelset shaft below the bogie frame.

For the sake of simplicity, the remainder of the description will examine more closely only the separable axle-driven generator, because the inseparable generator emerges analogously from the description of the separable generator.

The important thing is that the separable axle-driven generator consists of two halves arranged substantially symmetrically to each other, namely of a separable stator housing which can be joined together via connecting flanges, thus producing a respective upper and lower stator half-housing, and also of a rotor which is arranged in the stator housing and is also separable, each rotor half respectively consisting of an inner and an outer rotor ring half.

The outer rotor ring half receives in this case the permanent magnets, whereas the inner rotor ring half forms the rotor body. The important thing is that the rotor body, with webs oriented radially outward and distributed uniformly over the circumference, is screwed to the outer rotor ring half via screw connections.

These two assembled rotor ring halves are joined together in the region of the rotor body via associated screw connections, thus producing a peripheral, inner clamping receptacle which overlaps the wheelset shaft and is clamped thereto at this location.

A clamping receptacle of this type is able to transmit very high torques and does not in fact require any farther rotational engagement members.

Obviously, the invention is not restricted to this embodiment. Keyways and the like can also be provided for further rotational engagement.

Each outer rotor ring half consists of rotor press plates which are each arranged at the end face, are oriented parallel to one another, are distributed uniformly over the circumference of the rotor ring half and are joined together at the end face by tension bolts extending in the axial direction.

The rotor sheets are arranged between the rotor press plates and there are provided in the rotor sheets radially outwardly oriented slots in which permanent magnets are received.

A large number of permanent magnets are, in this case, distributed uniformly over the circumference, outwardly oriented in the radial direction. The permanent magnets can also be arranged differently.

The generator in the illustrated embodiment is therefore a brushless, permanently excited three-phase generator, because the induction voltages are generated in the stator-side windings.

The invention is not, however, restricted to this embodiment. The invention can also relate to three-phase generators equipped with brushes or else externally excited three-phase generators.

Similarly, the invention is not restricted to three-phase generators. Two-phase or multiphase generators could also be used.

Since two completely symmetrical rotor ring halves and two substantially symmetrical stator ring halves are provided, this leads to the two stator ring windings also each being electrically isolated.

The upper stator ring winding and the lower stator ring winding are therefore guided out from the stator separately and combined and connected in a clamping plate secured to the housing.

The foregoing description has referred in all cases to an “axle-driven generator”, although the invention is not restricted thereto. Obviously, any axle-driven generator is also able to function as a motor when current is passed through the stator winding.

It is therefore also possible, in accordance with the present invention, to operate the axle-driven generator as a motor.

In a development of the invention, it is also provided, for the transmission of torque, that the stator housing of the axle-driven generator—the rotor of which is rotationally engaged with the wheelset shaft—is connected to the bogie frame via what is known as a torque bracket. This also acts as a safety means which is intended to be triggered should the axle-driven generator seize up and block the wheelset shaft. In this case, a very high torque is transmitted via the stator housing to the torque bracket which is attached to the outside of the stator housing and has a stay bolt with an associated emergency cut-off point which is therefore broken off, thus releasing the axle-driven generator from the bogie frame. Once this connection has been cancelled in an emergency, the axle-driven generator will in this case revolve freely with the wheelset shaft, without blocking the wheelset shaft.

The subject-matter of the present invention emerges not only from the subject-matter of the individual claims, but also from the combination of the individual claims with one another.

All of the details and features disclosed in the documents, including the abstract, in particular the spatial configuration illustrated in the drawings, are claimed as being instrumental to the invention insofar as they are, individually or in combination, novel over the prior art.

### BRIEF DESCRIPTION OF THE DRAWINGS

The invention will be described hereinafter in greater detail with reference to drawings illustrating merely one embodiment. Further features instrumental to the invention and advantages of the invention will emerge from the drawings and the description thereof.

FIG. 1 is a perspective view from below of the bogie frame of a railway wagon, showing the position for installation of the axle-driven generator;

FIG. 2 is a perspective external view of the axle-driven generator;

FIG. 3 shows the axle-driven generator according to FIG. 3, partially opened;

FIG. 4 is a perspective view of the rotor half;

FIG. 5 is a front view of the axle-driven generator;

FIG. 6 is a cross-section through the axle-driven generator; and

FIG. 7 is a front view, partly in cross-section, of the axle-driven generator, showing a torque bracket.

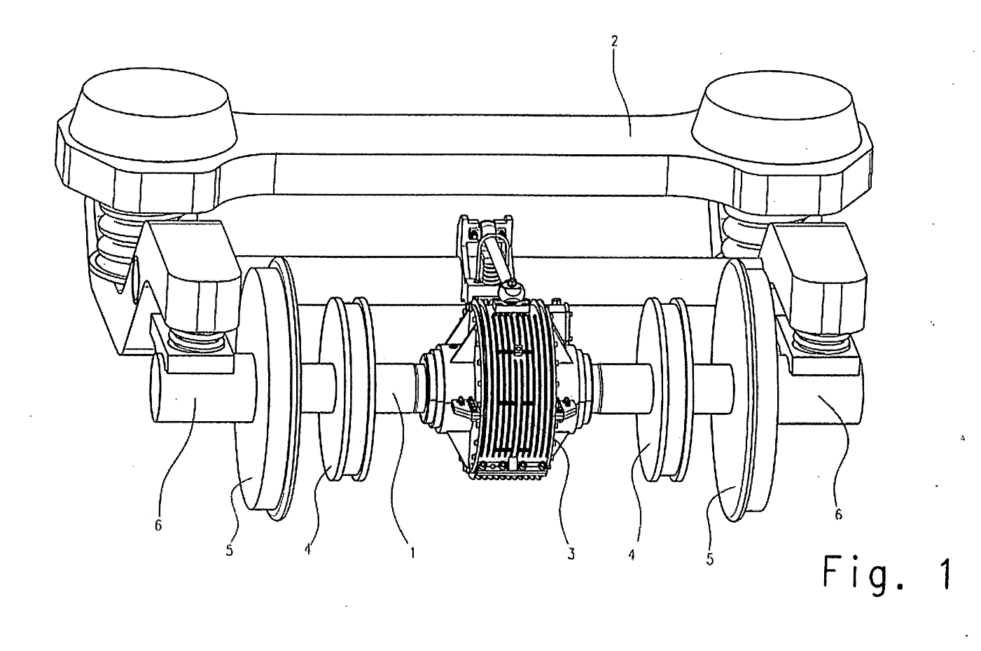

FIG. 1 is a perspective view from below of a railway wagon. Attached to a bogie frame 2 is a wheelset shaft 1 with which a brake disc 4 and an outer wheel disc 5 are rotationally engaged.

Also connected to the bogie frame 2 is an outer axle bearing 6 for mounting the wheelset shaft 1.

The important thing is that the axle-driven generator 3 is attached directly to the wheelset shaft 1 in that the wheelset shaft 1 passes directly through said axle-driven generator, which is of two-part construction.

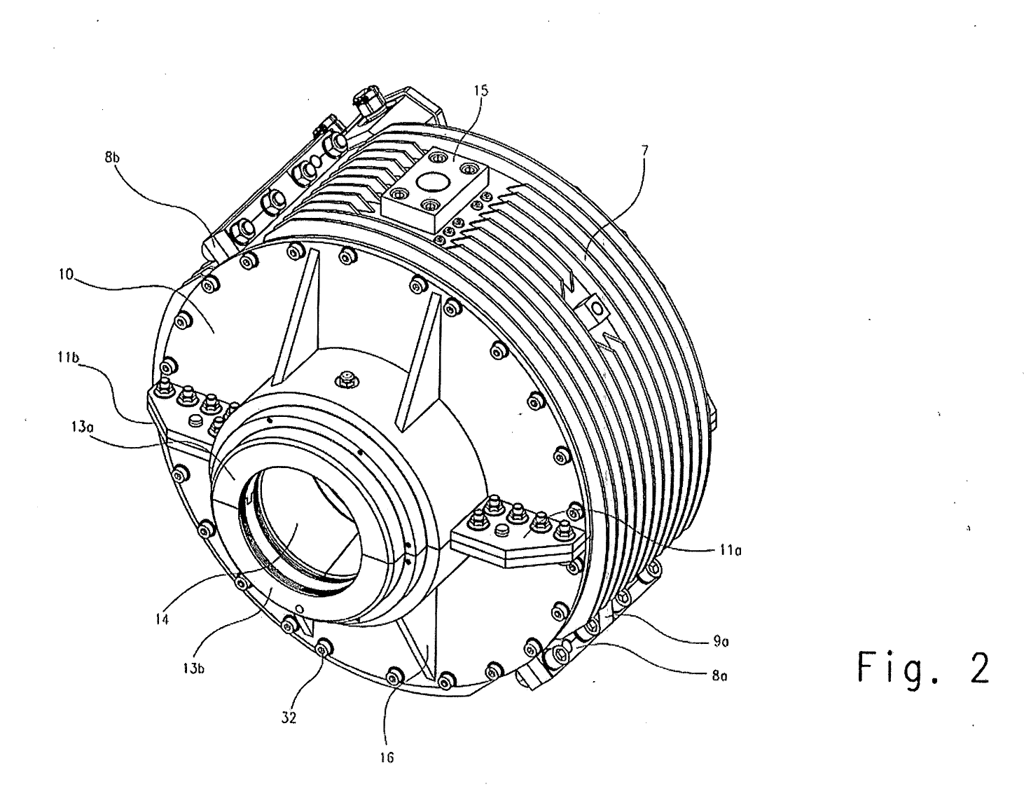

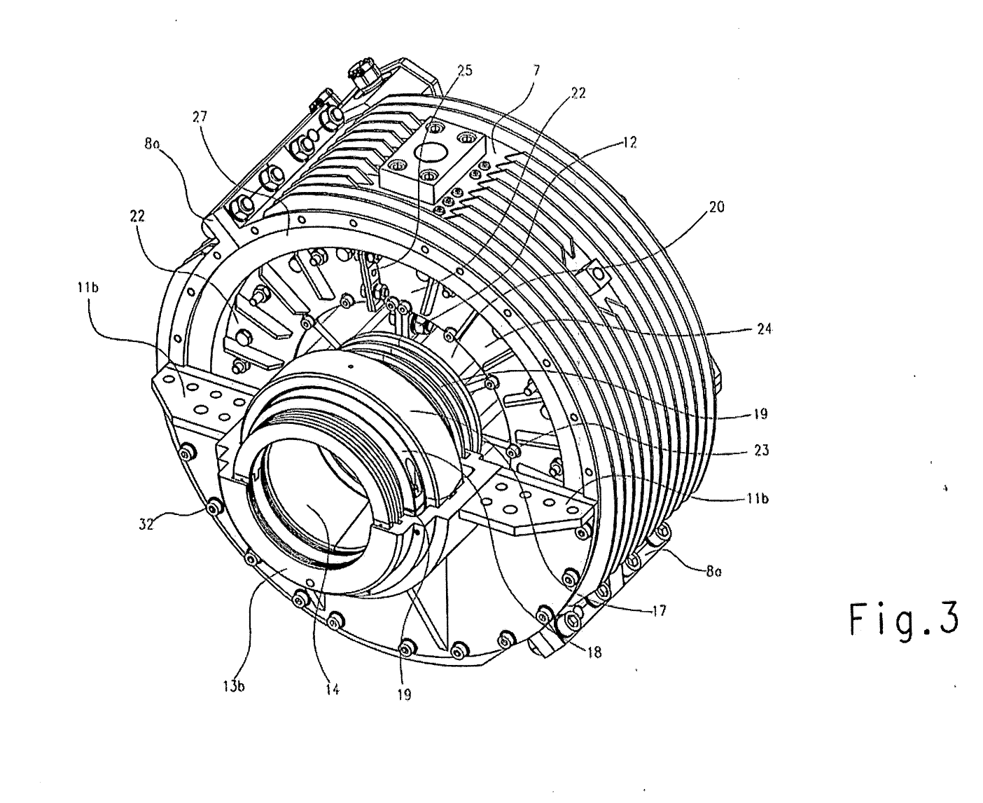

Further details of the construction of the separated axle-driven generator 3 emerge from FIG. 2 and 3.

### DETAILED DESCRIPTION OF THE PREFERRED EMBODIMENT

The stator housing 7 is of two-part construction and consists of an upper and a lower ring half, the two ring halves being joined together by connecting flanges 8a, 8b.

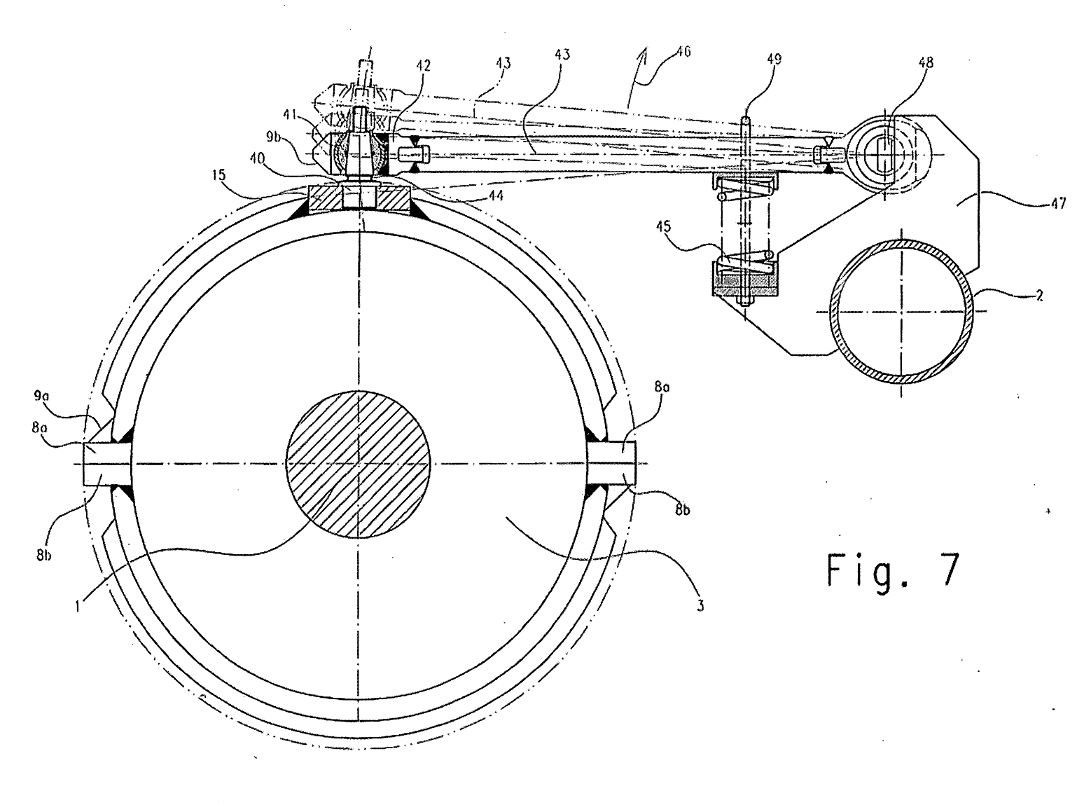

A receptacle 15 for attachment of the torque bracket illustrated in FIG. 7 is shown to be rotationally engaged with the outer circumference of the upper stator housing 7.

FIG. 2 shows that the wheelset shaft 1 passes through the shaft hole 14 in the rotor and is rotationally engaged with the rotor, a bearing shell 13, which is also separated and is formed from the bearing shell halves 13a, 13b, being visible.

FIG. 2 also shows the end-face bearing shield 10 which is screwed to the stator housing 7 using screw connections 32.

The bearing shield 10 is flanged to the bearing shell 13 using reinforcement ribs 16.

The opposing connecting flanges 11 shown in the drawing are also separated and consist of the connecting flanges 11a, 11b which are screwed together.

The two bearing shield halves 10 are joined together in the region of the connecting flanges.

In FIG. 3, the upper half of the bearing shield 10 has been removed to reveal the internal construction of the rotor.

It will be noted first of all that merely the lower connecting flange 11b remains on both sides, whereas the upper connecting flanges 11a are missing, because the corresponding upper portion of the bearing shield 10 has also been removed.

The bearing has a bearing outer ring 17 and carries—as shown in FIG. 6—cylindrical roller bearings 39.

Labyrinth seals 19 are arranged axially inside and outside the bearing outer ring 17. A bearing guide 18 axially secures—as shown in FIG. 6—the cylindrical roller bearing 39.

The important thing is that the rotor consists generally of an inner rotor ring half 26 and an outer rotor ring half 24.

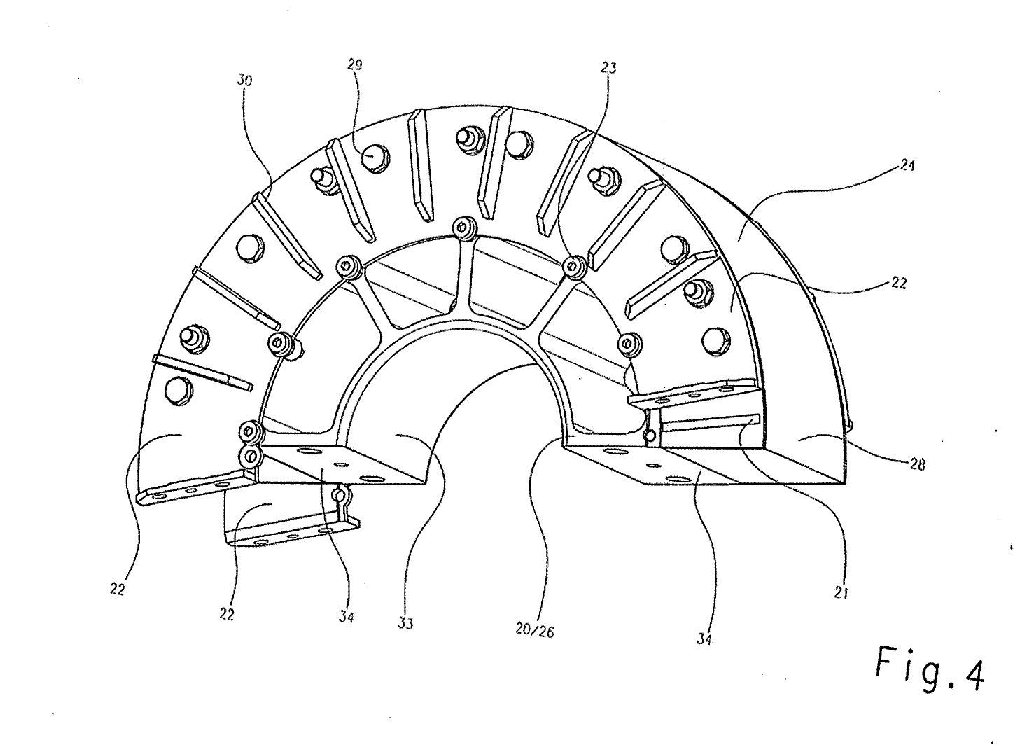

The inner rotor ring half 26 consists substantially of the rotor body 20 (see also FIG. 4) which is in the form, for example, of a cast part and has a large number of ribs pointing in the radial direction. These ribs are connected to the rotor body 20 in a materially integral manner.

The rotor body forms at its end face, in each case, flange faces 34, in the region of which the upper rotor half and the lower rotor half are joined together via associated screw connections.

The inner rotor ring half is screwed to the opposing, symmetrically arranged other rotor ring half using screw connections 12.

If, in the remainder of the description, merely individual parts are provided with reference numerals in the drawings, it is to be understood that this is not in any way restrictive. As the half-parts are entirely rotationally-symmetrical, a few basic parts of either symmetrical half have been provided with reference numerals merely for the sake of simplicity.

Obviously, with respect to a central parting plane on the opposing side, precisely the same parts having the same reference numerals are provided.

The inner rotor ring half 26 is screwed to the outer rotor ring half 24 via fastening screws 23.

The outer rotor ring half consists of rotor press plates 22 which are arranged in each case externally (at the end face) and are joined together, over their axial length, by associated tension bolts 29.

The end faces of the rotor press plates 22 cover the rotor sheets 28 which have openings or slots for permanent magnets 21 inserted therein. Cooling ribs 30 are formed integrally with the rotor press plates 22.

The rotor plates are joined together via screw connections 25 in order thus to achieve a fully encircling (self-contained) annular rotor.

FIG. 3 shows the stator winding 27 which extends merely over a circumferential angle of 180° and is electrically isolated from the opposing, other stator winding 27.

The terminals of the stator windings are guided outward and interconnected in a clamping board secured to the housing in order optionally to connect the two electrically isolated stator windings in parallel or else in series.

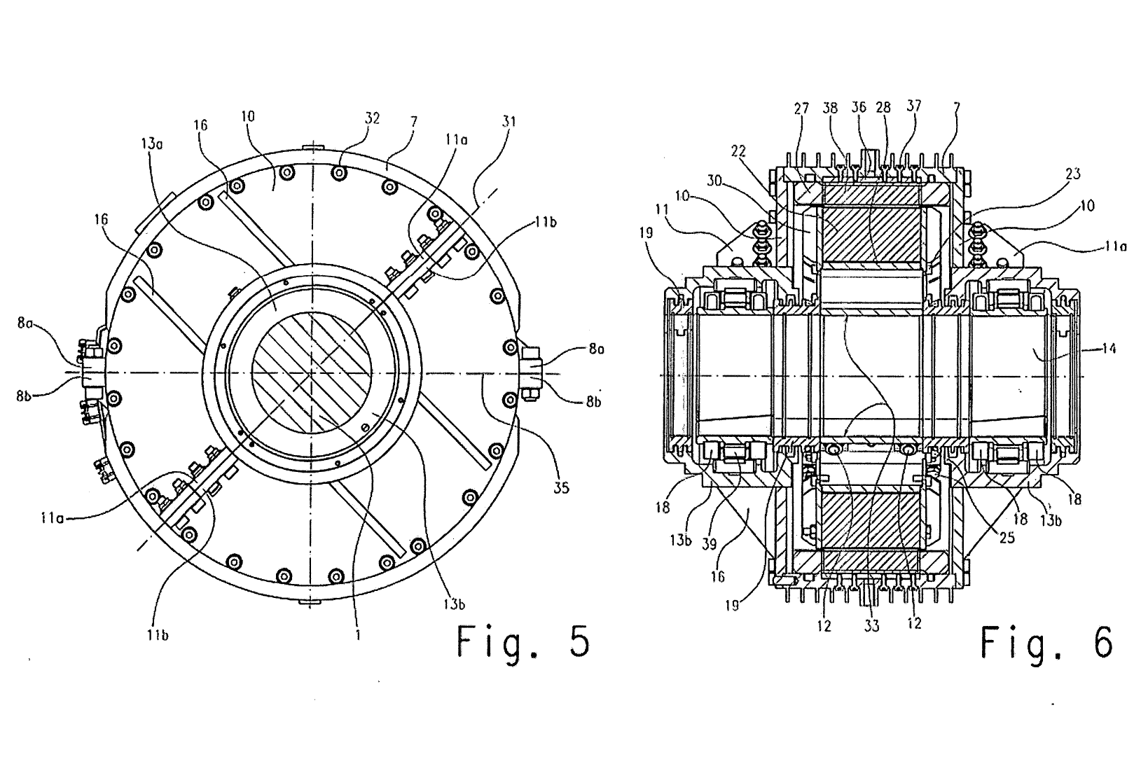

FIG. 5 also indicates that the bearing shield 10 is separated in the region of a parting plane 31, so this parting plane extends through the connecting flanges 11a, 11b.

It is also shown that the stator housing 7 is separated in the region of the parting plane 35 and the connection is produced using the aforementioned connecting flanges 8a, 8b.

It is thus possible to screw together the connecting flanges 34 of the rotor via the screw connections 25 and 12 in order thus to achieve an inner clamping receptacle 33 for the shaft hole 14.

The clamping receptacle encompasses in an interlocking manner the wheelset shaft 1, the entire length of which passes through the shaft hole 14.

FIG. 6 shows further details of the stator construction. The laminated core of the stator sheet 38 is drawn radially outwardly into the stator housing 7 and held therein via groove nuts 36 and screw connections 37.

FIG. 7 shows the aforementioned torque bracket.

Rotationally engaged with the outer circumference of the stator housing 7 is the aforementioned receptacle 15 into which there is inserted a stay bolt 40 with an associated emergency cut-off point 44.

The emergency cut-off point 44 is formed by a collar of reduced diameter in the region of the stay bolt 40, which collar breaks off, in the event of an undesirably high torque being applied to the stay bolt, and thus detaches the stay bolt 40.

Arranged on the upper portion of the stay bolt 40 is a rubber bearing 41 which is overlapped by a bearing bush 42 of a support arm 43.

The free end of the support arm 43 is rotatably received in a pivot bearing 48 on the bogie frame 2, the pivot bearing 48 being arranged on the bogie frame 2 in the region of a bearing block 47.

In order to facilitate, in an emergency, complete removal of the torque bracket from the rapidly revolving axle-driven generator 3, there is also arranged on the bogie frame a further compression spring 45 which has, at its upper end, a bolt which passes through the support arm 43. The support arm 43 is thus biased by the compression spring 45 in the direction of arrow 46.

As soon as the emergency cut-off point 44 is opened, the support arm 43 is thrown upward in the direction of arrow 46 and the axle-driven generator 3 is able to revolve freely and does not cause the wheelset shaft 1 to become blocked.

In this emergency, the associated cable connections to the axle-driven generator are also cut off. In a first embodiment, the cables are connected with frictional engagement and in an electrically conductive manner by screws in the region of the parting plane. As soon as an inadmissibly high torque is exerted on the cable in the longitudinal direction, this frictionally engaged connection is opened and the cables are released.

In a different embodiment, it can also be provided that the cables are joined together via plugs assembled in the direction of traction, so the plug-in connections are cancelled in the event of an inadmissibly high tractive force being exerted on the cables.

Arranged on the support arm 43 is a run-on bevel 9b which cooperates, at the outer circumference of the stator housing 7, with an associated run-on bevel 9a secured to the housing. On release of the cut-off point, the support arm is cast away from the outer circumference of the stator housing, accelerated by the meeting of the two run-on bevels 9a, 9b, and can no longer damage the rapidly revolving stator housing.

In order to prevent damage to the frame of the carriage when the support arm is cast toward the frame, a retaining device 49 is provided in the region of the stay bolt of the compression spring 45 in order to delimit the outward swivelling of the support arm in the direction of arrow 46.

### LEGEND TO THE DRAWINGS

1 Wheelset shaft

2 Bogie frame

3 Axle-driven generator

4 Brake disc

5 Wheel disc

6 Axle bearing

7 Stator housing

8 Connecting flange a, b

9 Run-on bevel a, b

10 Bearing shield

11 Connecting flange a, b

12 Screw connection

13 Bearing shell a, b

14 Shaft hole

15 Receptacle

16 Reinforcement rib

17 Bearing outer ring

18 Bearing guide

19 Labyrinth seal

20 Rotor body

21 Permanent magnet

22 Rotor press plate

23 Fastening screws

24 Outer rotor ring half

25 Screw connection

26 Inner rotor ring half

27 Stator winding

28 Rotor block

29 Tension bolt

30 Cooling rib

31 Parting plane (bearing shield)

32 Screw connection

33 Clamping receptacle

34 Flange face

35 Parting plane (stator housing)

36 Groove nut

37 Screw connection

38 Stator sheet

39 Cylindrical roller bearing

40 Stay bolt

41 Rubber bearing

42 Bearing bush

43 Support arm

44 Emergency cut-off point

45 Compression spring

46 Direction of arrow

47 Bearing block

48 Pivot bearing

49 Retaining device

1. Axle-driven generator for railway carriages and the like, comprising at least one axle-driven generator (3), the rotor (20, 24, 26) of which is rotationally engaged with the wheelset shaft (1) and the stator housing (7) of which is secured to the housing, wherein the axle-driven generator (3) is flanged directly on the wheelset shaft (1), which passes through said axle-driven generator.

2. Axle-driven generator according to claim 1, wherein the axle-driven generator is of two-part construction and consists of two halves which are arranged substantially mirror-symmetrically to each other and are screwed together.

3. Axle-driven generator according to claim 1, wherein the axle-driven generator is constructed as a brushless, permanently excited three-phase generator.

4. Axle-driven generator according to claim 1, wherein the axle-driven generator (3) generates an electrical power of up to 30 kW.

5. Axle-driven generator according to claim 1, wherein the axle-driven generator (3) sits directly on the wheelset shaft (1) and its rotor (20, 24, 26) is rotationally engaged therewith, whereas the stator (7) is supported in a non-rotatable manner on a bogie frame (2) or another fixed part of the wagon.

6. Axle-driven generator according to claim 1, wherein the rotor (20, 24, 26) of the axle-driven generator (3) encompasses the wheelset shaft (1) with a rotationally engaged clamping connection.

7. Axle-driven generator according to claim 1, wherein the axle-driven generator (3) consists of two parts which are arranged substantially mirror-symmetrically to each other and are attached to the wheelset shaft using screw connections, and in that the wheelset shaft (1) passes through the shaft hole (14) in the axle-driven generator (3) with frictional or interlocking engagement.

8. Axle-driven generator according to claim 1, wherein the separable axle-driven generator (3) consists of two halves arranged substantially mirror-symmetrically to each other, namely of a separable stator housing (7) which can be joined together via connecting flanges, thus producing a respective upper and lower stator half-housing, and also of a rotor (20, 24, 26) which is arranged in the stator housing (7) and is also separable.

9. Axle-driven generator according to claim 1, wherein each rotor half respectively consists of an inner and an outer rotor ring half (24, 25).

10. Axle-driven generator according to claim 9, wherein the outer rotor ring half (24) receives the permanent magnets and in that the inner rotor ring half (26) forms the rotor body (20).

11. Axle-driven generator according to claim 9, wherein the two assembled rotor ring halves are joined together in the region of the rotor body (20) via associated screw connections, thus producing a peripheral, inner clamping receptacle which overlaps the wheelset shaft and is clamped thereto at this location.

12. Axle-driven generator according to claim 9, wherein each outer rotor ring half (24) consists of rotor press plates (22) which are each arranged at the end face, are oriented parallel to one another, are distributed uniformly over the circumference of the rotor ring half (24) and are joined together at the end face by tension bolts (29) extending in the axial direction.

13. Axle-driven generator according to claim 12, wherein rotor sheets (28) are arranged between the rotor press plates (22) and in that there are provided in the rotor sheets (28) radially outwardly oriented slots in which permanent magnets (21) are received.

14. Axle-driven generator according to claim 5, wherein the stator housing (7) of the axle-driven generator is connected to the bogie frame (2) via a torque bracket.

15. Axle-driven generator according to claim 14, wherein the torque bracket consists of a support arm (43) which overlaps a stay bolt (40) which is rigidly connected to the outer circumference of the stator housing (7) and forms a collar of reduced diameter as an emergency cut-off point (44).

16. Axle-driven generator according to claim 15, wherein the support arm (43) is radially outwardly biased by a compression spring (45) in the direction of arrow (46).

17. Axle-driven generator according to claim 1, wherein in the event of emergency triggering even the cable connections to axle-driven generator (3) can be cut off
